(19) United States
(12) Patent Application Publication
(10) Pub. No.: US 2020/0335051 A1
(43) Pub. Date: Oct. 22, 2020

(54) LIQUID CRYSTAL DISPLAY DEVICE

(71) Applicant: Japan Display Inc., Minato-ku (JP)

(72) Inventor: Hisashi TOMITANI, Tokyo (JP)

(73) Assignee: Japan Display Inc., Minato-ku (JP)

(21) Appl. No.: 16/844,082

(22) Filed: Apr. 9, 2020

(30) Foreign Application Priority Data
Apr. 16, 2019 (JP) 2019-077935

(51) Int. Cl. G09G 3/36; G09G 5/10

(52) U.S. Cl. CPC G09G 3/3607; G09G 2320/0646; G09G 5/10

(57) ABSTRACT

According to one embodiment, a liquid crystal display device includes a plurality of light sources, a display panel including a liquid crystal layer, and a driver configured to cause the light sources to emit light in series in a time-divisional matter to display an image on the display panel. The driver is configured to cause at least one of the light sources to emit light in a period from a first light emission starting time until a light emission stopping time when the image is displayed with a first brightness, and configured to cause at least one of the light sources to emit light in a period from a second light emission starting time until the light emission stopping time when the image is displayed with a second brightness.

### CROSS-REFERENCE TO RELATED APPLICATIONS

This application is based upon and claims the benefit of priority from Japanese Patent Application No. 2019-077935, filed Apr. 16, 2019, the entire contents of which are incorporated herein by reference.

### FIELD

Embodiments described herein relate generally to a liquid crystal display device.

### BACKGROUND

As a liquid crystal display device for displaying an image, for example, a liquid crystal display device (transparent display) using a polymer dispersed liquid crystal (PDLC) and having high transmissivity is known.

In this liquid crystal display device, to improve the transmissivity, for example, field sequential driving is adopted. Field sequential driving is a driving method for realizing color display by switching the light emission of a plurality of light sources (LEDs) in each pixel in a time-divisional manner.

However, in a liquid crystal display device using field sequential driving, the response speed of the liquid crystal is insufficient, and the display quality may be degraded by color mixture, etc.

### BRIEF DESCRIPTION OF THE DRAWINGS

FIG. 1 shows an example of a cross-sectional surface of a display panel provided in a liquid crystal display device according to a first embodiment.

FIG. 2 is shown for explaining the effect of a liquid crystal layer.

FIG. 3 is shown for explaining the effect of the liquid crystal layer.

FIG. 4 is shown for explaining an example of the general structure of the liquid crystal display device.

FIG. 5 is shown for explaining the outline of the operation of the liquid crystal display device in which field sequential driving is adopted.

FIG. 6 is shown for explaining the outline of the operation of a liquid crystal display device according to a comparison example of the present embodiment when an image is displayed with a minimum brightness.

FIG. 7 is shown for explaining the outline of the operation of the liquid crystal display device according to the present embodiment when an image is displayed with a minimum brightness.

FIG. 8 is shown for explaining the outline of the operation of a liquid crystal display device according to a second embodiment when an image is displayed with a maximum brightness.

FIG. 9 is shown for explaining the outline of the operation of the liquid crystal display device according to the present embodiment when an image is displayed with a minimum brightness.

### DETAILED DESCRIPTION

In general, according to one embodiment, a liquid crystal display device includes a plurality of light sources having different light emission colors, a display panel including a liquid crystal layer irradiated by the light sources, and a driver configured to cause the light sources to emit light in series in a time-divisional matter to display an image on the display panel. The driver is configured to cause at least one of the light sources to emit light in a period from a first light emission starting time until a light emission stopping time when the image is displayed with a first brightness, and configured to cause at least one of the light sources to emit light in a period from a second light emission starting time later than the first light emission starting time until the light emission stopping time when the image is displayed with a second brightness less than the first brightness.

Embodiments will be described hereinafter with reference to the accompanying drawings.

### First Embodiment

The liquid crystal display device of the present embodiment is assumed to be, for example, a liquid crystal display device (transparent display) using a polymer dispersed liquid crystal (PDLC) and having high transmissivity. Although details are described later, the liquid crystal display device includes a display panel, and the display panel includes a polymer dispersed liquid crystal layer (hereinafter, simply referred to as a liquid crystal layer) as a light modulating layer. In the display panel, the liquid crystal layer is irradiated by a light source from a side surface of the display panel, and the light from the light source is emitted from the liquid crystal layer, thereby displaying an image (a video).

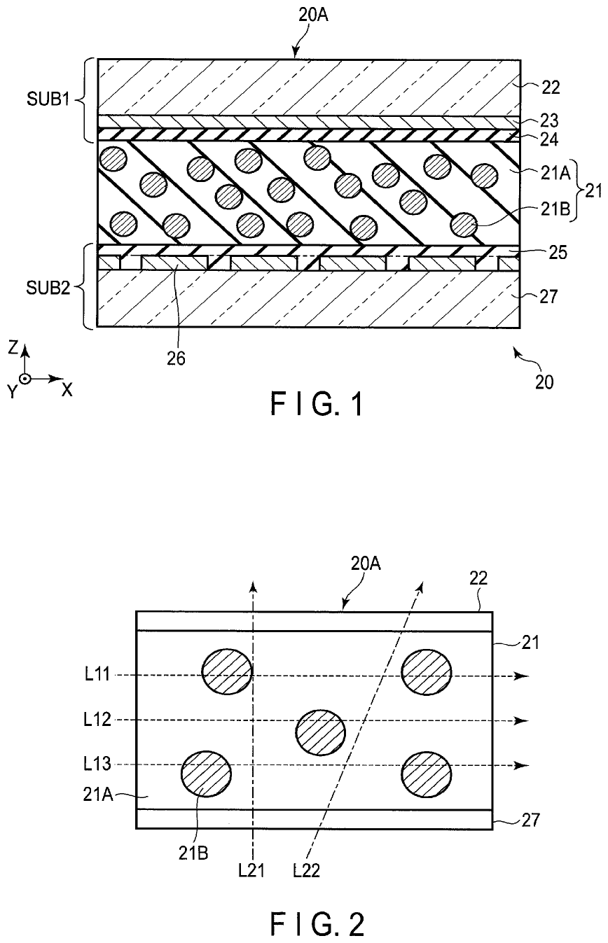

FIG. 1 shows an example of a cross-sectional surface of a display panel provided in a liquid crystal display device according to the present embodiment. As shown in FIG. 1, the display panel 20 includes a first substrate SUB1, a second substrate SUB2, and a liquid crystal layer 21 provided between the first substrate SUB1 and the second substrate SUB2.

The first substrate SUB1 includes a transparent substrate 22, a common electrode 23 and an alignment film 24 in order to a side approaching the liquid crystal layer 21.

The second substrate SUB2 includes an alignment film 25, pixel electrodes 26 and a transparent substrate 27 in order to a side moving away from the liquid crystal layer 21.

Although not shown in FIG. 1, the second substrate SUB2 includes scanning lines, signal lines orthogonal to the scanning lines, and pixels provided in the vicinities of the intersections between the scanning lines and the signal lines, as described later. Each pixel includes a switching element such as a thin-film transistor (TFT), etc.

The transparent substrate 22 of a pair of transparent substrates 22 and 27 includes a light emission surface 20A on a side opposite to the side on which the common electrode 23 is provided. The transparent substrate 27 is provided such that elements including, for example, the liquid crystal layer 21, are interposed between the transparent substrate 27 and the transparent substrate 22. The transparent substrates 22 and 27 support the liquid crystal layer 21. In general, the transparent substrates 22 and 27 are formed of transparent substrates (for example, glass plates or plastic films) for visible light.

Of a pair of electrodes, specifically, of the common electrode 23 and the pixel electrodes 26, the common electrode 23 is provided on the surface of the transparent substrate 22 on the liquid crystal layer 21 side, and is, for example, a single sheet electrode formed over the entire in-plane structure.

Each pixel electrode 26 is provided on the surface of the transparent substrate 27 on the liquid crystal layer 21 side, and is formed into an island shape. A plurality of pixel electrodes 26 are provided in the display panel 20, and are arranged in matrix in an X-direction and a Y-direction. Each pixel electrode 26 is connected to the above switching element (hereinafter, referred to as a pixel transistor), and is driven to apply voltage to the liquid crystal layer 21.

The common electrode 23 and the pixel electrodes 26 are formed of a transparent conductive material such as indium tin oxide (ITO) or indium zinc oxide (IZO). The transparent conductive material should be preferably a material in which the absorption of visible light is less. The details of the layout of the common electrode 23 and the pixel electrodes 26 are described later.

The alignment film 24 is provided between the common electrode 23 and the liquid crystal layer 21. The alignment film 25 is provided between the pixel electrodes 26 and the liquid crystal layer 21. For example, the alignment films 24 and 25 align the liquid crystal molecules and polymer used for the liquid crystal layer 21. As the types of the alignment films 24 and 25, for example, a vertical alignment film and a horizontal alignment film are considered. In the structural example shown in FIG. 1, horizontal alignment films are used for the alignment films 24 and 25. As the horizontal alignment films, for example, alignment films formed by applying alignment treatment to resinous films such as polyimide and polyamide-imide are used. The alignment treatment includes, for example, rubbing treatment and light alignment treatment. When plastic films are used for the transparent substrates 22 and 27, in terms of the prevention of the deformation of the transparent substrates 22 and 27, the baking temperature after the application of the alignment films 24 and 25 to the surfaces of the transparent substrates 22 and 27 in the manufacturing process should be preferably low. Thus, for the alignment films 24 and 25, polyamide-imide which can be formed at a temperature less than or equal to 100° C. should be preferably used.

The alignment films 24 and 25 should only have a function of aligning liquid crystal molecules and a polymer. For example, the liquid crystal molecules and polymer used for the liquid crystal layer 21 can be also aligned by applying an electric field or a magnetic field between the common electrode 23 and the pixel electrodes 26. In this case, neither the alignment film 24 nor the alignment film 25 may be used. In other words, the alignment state of liquid crystal molecules and polymer in a voltage-applied state can be fixed by the irradiation with ultraviolet rays and the preparation of a polymer while applying an electric field or a magnetic field between the common electrode 23 and the pixel electrodes 26. When voltage is used for the alignment of the liquid crystal molecules and polymer, separate electrodes may be formed for alignment and driving, or a dual-frequency liquid crystal in which the sign of the dielectric anisotropy is inverted based on a frequency may be used as a liquid crystal material. When a magnetic field is used to align the liquid crystal molecules and polymer, a material in which the magnetic susceptibility anisotropy is great should be preferably used for the liquid crystal molecules and polymer. For example, a material having a large number of benzen rings should be preferably used.

The liquid crystal layer 21 is provided between the pair of transparent substrates 22 and 27. The liquid crystal layer 21 exhibits a scattering property or transparency entirely or partially with respect to the light from a light source based on the magnitude or direction of the electric field generated by the common electrode 23 and the pixel electrodes 26.

Specifically, the liquid crystal layer 21 exhibits transparency with respect to the light from a light source when voltage is not applied to the common electrode 23 and the pixel electrodes 26. The liquid crystal layer 21 exhibits a scattering property with respect to the light from a light source when voltage is applied to the common electrode 23 and the pixel electrodes 26. Thus structure is called normally black.

The liquid crystal layer 21 is a composite layer (polymer dispersed liquid crystal layer) including a polymer 21A described above and liquid crystal molecules 21B dispersed in the polymer 21A. The polymer 21A and the liquid crystal molecules 21B have optical anisotropy.

The response speed to an electric field differs between the polymer 21A and the liquid crystal molecules 21B. For example, the polymer 21A has a streaky structure or porous structure which does not respond to an electric field, or has a streaky structure or rod-shaped structure having a response speed less than the response speed of the liquid crystal molecules 21B. The polymer 21A is formed of a polymeric material obtained by polymerizing a low-molecular-weight monomer. The polymer 21A is formed by polymerizing a material (for example, a monomer) aligned in the alignment direction of the alignment films 24 and 25 and having alignment property and polymerization property by at least one of heat and light.

The liquid crystal molecules 21B are structured so as to mainly include, for example, a liquid crystal material, and have a response speed sufficiently faster than the response speed of the polymer 21A. The liquid crystal molecules 21B are, for example, rod-shaped molecules. For the liquid crystal molecules 21B, a material having a positive dielectric anisotropy (so-called “positive liquid crystal”) should be preferably used. When the polymer 21A has a streaky structure or a rod-shaped structure, the liquid crystal molecules 21B are aligned in parallel with, for example, the long axial direction (alignment direction) of the streaky structure or rod-shaped structure of the polymer 21A.

For the monomer forming the above polymer 21A and having alignment property and polymerization property, a material optically having anisotropy and combined with a liquid crystal may be used. In the present embodiment, for example, a low-molecular-weight monomer curing with ultraviolet rays is used. In a state where no voltage is applied, the direction of the optical anisotropy of the polymer 21A should preferably conform to that of the liquid crystal molecules 21B. Thus, before curing with ultraviolet rays, the liquid crystal material and the low-molecular-weight monomer should be preferably aligned in the same direction. When the liquid crystal molecules 21B are rod-shaped molecules, it is preferable that the used monomer material also have a rod-shape. As described above, as the monomer material, a material having both polymerization property and liquid crystallinity should be preferably used. For example, as a polymerizable functional group, the material should preferably have at least one functional group selected from a group consisting of an acrylate group, a methacrylate group, an acryloyloxy group, a methacryloyloxy group, a vinyl ether group and epoxy group. These functional groups can be polymerized by applying ultraviolet rays, infrared light or electron beams, or heating. To prevent the reduction in the degree of alignment at the time of irradiation with ultraviolet rays, a polyfunctionalized liquid crystal material may be added. When the polymer 21A has the above streaky structure, as the raw material of the polymer 21A, a bifunctional liquid crystal monomer should be preferably used. For the raw material of the polymer 21A, a monofunctional monomer may be added to adjust a temperature exhibiting liquid crystallinity, or a trifunctional or higher functionality monomer may be added to improve crosslink density.

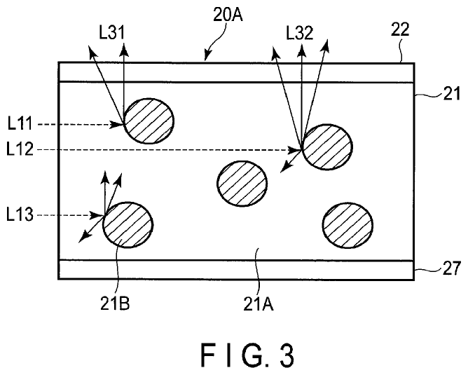

Now, this specification briefly explains the effect of the above liquid crystal layer 21 with reference to FIG. 2 and FIG. 3.

FIG. 2 shows the outline of the effect of the liquid crystal layer 21 in a state where predetermined voltage is not applied to the common electrode 23 and the pixel electrodes 26 (hereinafter, referred to as a voltage-non-applied state).

In a voltage-non-applied state (in other words, a state where no electric field is generated in the liquid crystal layer 21), the direction of the optical axis of the polymer 21A conforms to that of the liquid crystal molecules 21B. Thus, the difference in the refraction index is extremely less in all directions including a frontal direction and an oblique direction.

Thus, for example, light beams (incident light beams) L11 to L13 indicated by chain lines, entering the liquid crystal layer 21 from a side surface and emitted from a light source pass through the liquid crystal layer 21 without being scattered in the liquid crystal layer 21. A light beam from the light source to the transparent substrate 22 or 27 side is subjected to total reflection and is not emitted to the outside.

Light beams L21 and L22 indicated by alternate long and short dash lines and entering the transparent substrate 27 from the external side of the transparent substrate 27 in a direction penetrating the transparent substrate 27, the liquid crystal layer 21 and the transparent substrate 22 also pass through the liquid crystal layer 21 without being scattered in the liquid crystal layer 21 and are emitted from the light emission surface 20A of the transparent substrate 27. Thus, in a voltage-non-applied state, the liquid crystal layer 21 has high transparency.

FIG. 3 shows the outline of the effect of the liquid crystal layer 21 in a state where predetermined voltage is applied to the common electrode 23 and the pixel electrodes 26 (hereinafter, referred to as a voltage-applied state).

In a voltage-applied state (in other words, a state where an electric field is generated in the liquid crystal layer 21), the direction of the optical axis of the polymer 21A intersects with that of the liquid crystal molecules 21B. Thus, the difference in the refraction index is great in all directions including a frontal direction and an oblique direction.

In this way, a high scattering property can be obtained in the liquid crystal layer 21. In this case, incident light beams L11 to L13 from a light source are scattered in the liquid crystal layer 21. These scattered light beams L31 and L32 are emitted from the light emission surface 20A of the transparent substrate 22. Thus, for example, when the display panel 20 (the light emission surface 20A of the transparent substrate 22) is observed, scattered light beams L31 and L32 can be visually confirmed.

In other words, for example, when the display panel 20 is viewed from the front side, in a voltage-non-applied state, light which passed through the transparent substrate 27, the liquid crystal layer 21 and the transparent substrate 22 is visually confirmed. In a voltage-applied state, the light emitted from a light source and scattered in the liquid crystal layer 21 and further emitted is visually confirmed.

In the above explanation, the liquid crystal layer 21 obtains a high scattering property in a voltage-applied state. However, for example, the liquid crystal layer 21 may have a high scattering property in a voltage-non-applied state by causing the direction of the optical axis of the polymer 21A to conform to that of the liquid crystal molecules 21B in a voltage-applied state.

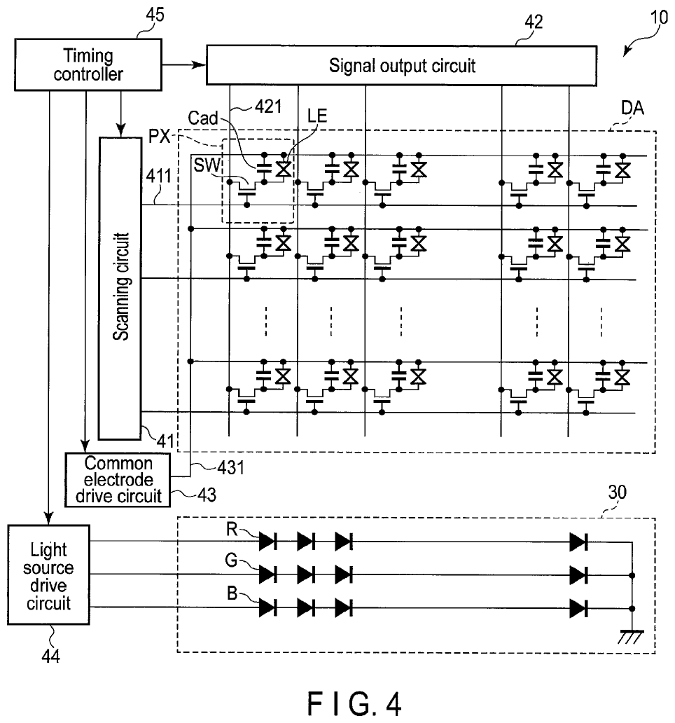

Now, this specification explains the general structure of the liquid crystal display device 10 according to the present embodiment with reference to FIG. 4. As shown in FIG. 4, the liquid crystal display device 10 includes a display area DA (matrix pixel area). In the display area DA, a plurality of pixels PX are arranged (arrayed) in matrix.

The liquid crystal display device 10 includes a scanning circuit 41, a signal output circuit 42, a common electrode drive circuit (driver) 43, a light source (LED) drive circuit (driver) 44 and a timing controller 45. For example, the scanning circuit 41 and the signal output circuit 42 are mounted on the second substrate SUB2 (glass) by a COG system. In this case, the common electrode drive circuit 43, the light source drive circuit 44 and the timing controller 45 are mounted on, for example, a printed board different from the scanning circuit 41 and the signal output circuit 42 described above.

Further, the scanning circuit 41, the signal output circuit 42 and the timing controller 45 may be structured as a single semiconductor integrated circuit. The semiconductor integrated circuit may be mounted by a COG system. In addition to the scanning circuit 41, the signal output circuit 42 and the timing controller 45, the entire part or a part of the common electrode drive circuit 43, the entire part or a part of the light source drive circuit 44, another control circuit in which the consumed power is less, etc., may be structured as a single semiconductor integrated circuit, and the semiconductor integrated circuit may be mounted by a CGO system.

Moreover, in the display area DA, a plurality of scanning lines (gate lines) 411 extending in the row direction of the pixels PX, a plurality of signal lines (source lines) 421 extending in the column direction of the pixels PX, and a power line 431 extending in parallel with the scanning lines 411 are provided.

The pixels PX are provided at the intersections between the scanning lines 411 and the signal lines 421.

Here, this specification explains the structure of each pixel PX. As shown in FIG. 4, each pixel PX includes a pixel transistor (pixel switch) SW, a liquid crystal element LE and a storage capacitance portion (auxiliary capacitance portion) Cad.

The gate electrode of each pixel transistor SW is electrically connected to a corresponding scanning line 411. One of the source electrode and the drain electrode of each pixel transistor SW is electrically connected to a corresponding signal line 421. The other one of the source electrode and the drain electrode of each pixel transistor SW is electrically connected to a corresponding liquid crystal element LE. In the following explanation, it is assumed that the source electrodes of the pixel transistors SW are connected to the signal lines 421, and the drain electrodes of the pixel transistors SW are connected to the liquid crystal elements LE.

Although not shown in FIG. 4, each liquid crystal element LE includes the liquid crystal layer 21, the pixel electrode 26 and the common electrode 23 provided at a position facing the pixel electrode 26 across the intervening liquid crystal layer 21. The pixel electrode 26 is connected to the drain electrode of the pixel transistor SW, and the common electrode 23 is connected to the power line 431.

The storage capacitance portion Cad is provided to stably apply voltage based on a video signal (an image signal) to the liquid crystal element LE (the liquid crystal layer 21). The storage capacitance portion Cad forms storage capacitance by a pair of electrodes. One of the electrodes is connected to the liquid crystal element LE (the pixel electrode 26) and the drain electrode of the pixel transistor SW. The other electrode is connected to the power line 431.

The scanning circuit 41 is connected to the scanning lines 411. The scanning circuit 41 applies on-voltage and off-voltage to the gate electrodes of the pixel transistors SW electrically connected to the scanning lines 411 via the scanning lines 411. When on-voltage is applied to the gate electrode of a pixel transistor SW, the source electrode of the pixel transistor SW is electrically continuous with the drain electrode of the pixel transistor SW.

The signal output circuit 42 is connected to the signal lines 421. The signal output circuit 42 supplies a video signal (output signal) to each pixel PX via the signal lines 421. In this way, a video signal is written to each pixel PX via a corresponding pixel transistor SW in which the source electrode is electrically continuous with the drain electrode.

The common electrode drive circuit 43 is connected to the power line 431. The common electrode drive circuit 43 supplies a drive signal (in other words, applies drive voltage) to the common electrode 23.

The light source drive circuit 44 is connected to the above light source 30 (LE), and drives the light emission of the light source 30. The light source 30 includes a plurality of light sources (light-emitting elements) having different light emission colors. Specifically, the light source 30 includes, for example, a red light source R which emits red light, a green light source G which emits green light and a blue light source which emits blue light. For the light emitting elements, for example, light-emitting diodes (LEDs) may be used. The light-emitting elements may be, for example, laser diodes (LDs).

The timing controller 45 controls various timings of the liquid crystal display device 10 as a whole. Specifically, the timing controller 45 outputs a frame signal, a field signal, etc., as described later, and controls the driving of the scanning circuit 41, the signal output circuit 42, the common electrode drive circuit 43, the light source drive circuit 44, etc.

Now, this specification explains the operation of the liquid crystal display device 10 according to the present embodiment. In the present embodiment, it is assumed that, as the driving method of the liquid crystal display device 10 when an image is displayed based on a video signal, field sequential driving (method) is adopted. Field sequential driving is a driving method for realizing color display by switching light emission among red, green and blue in each pixel PX in a time-divisional manner (in other words, by causing the red light source R, the green light source G and the blue light source B to emit light in series in a time-divisional manner).

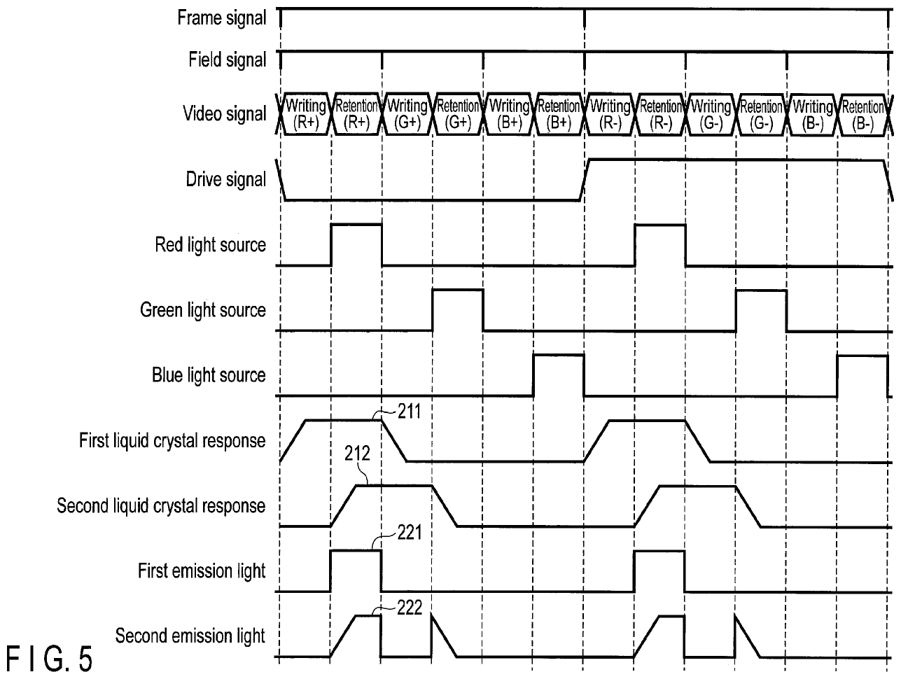

Here, this specification explains the outline of the operation of the liquid crystal display device 10 in which field sequential driving is adopted with reference to FIG. 5.

In FIG. 5, a frame signal is a signal for switching the image (frame) displayed in the display area DA of the liquid crystal display device 10. A field signal is a signal for switching the field in the above field sequential driving.

In this case, a frame period based on a frame signal (in other words, a period for displaying an image for a frame) is divided into a period (R period) for displaying the image (field) of a red component, a period (G period) for displaying the image (field) of a green component and a period (B period) for displaying the image (field) of a blue component.

Further, each of the above R period, G period and B period includes a period for writing a video signal to the pixels PX (hereinafter, referred to as a writing period) and a period for causing the pixels PX to retain the video signal (hereinafter, referred to as a retention period). In a writing period, the above scanning lines 411 are scanned in series, and a video signal is supplied to the signal lines 421. In this way, the video signal is written to the pixels PX. In a retention period, the state in which the video signal is written is retained by the pixels PX, and the light source of a corresponding color is caused to emit light (to be turned on).

Specifically, for example, when the red light source R is caused to emit light, light (red incident light) from the red light source R enters the liquid crystal layer 21. Here, as voltage is applied to the common electrode 23 and the pixel electrodes 26 based on the video signal retained in the pixels PX, the inside of the liquid crystal layer 21 transitions to a scattered state, and the scattered light of the red incident light is emitted. In this way, a red field can be displayed. The magnitude or the application time of the voltage applied to the liquid crystal layer 21 is determined based on the light intensity of the incident light and the red component of the image to be displayed.

In the above explanation, a red field is displayed in an R period. However, the same explanation is applied to a case where a green field is displayed by causing the green light source G to emit light in a G period and a case where a blue field is displayed by causing the blue light source B to emit light in a B period.

Since a liquid crystal needs to be performed alternate-current driving, the polarity of the voltage applied to the liquid crystal layer 21 (hereinafter, referred to as a liquid crystal application voltage) is inverted for each frame. In this case, inversion driving for displaying each positive-polarity (plus-polarity) field in series, subsequently inverting the polarity of the liquid crystal application voltage and displaying each negative-polarity (minus-polarity) field in series is performed. At this time, a drive signal Vcom applied to the common electrode 23 is inverted for each frame (frame period) based on the polarity of the above liquid crystal application voltage.

In the above explanation, the liquid crystal is driven by inverting the drive signal VCOM applied to the common electrode 23. However, the liquid crystal may be driven by other systems.

In the above field sequential driving, a video signal is written to each pixel PX in a writing period for each field, and the light source of a color corresponding to the field is caused to emit light in the retention period of the video signal. In this way, it is possible to display a red field in an R period, display a green field in a G period and display a blue field in a B period. In field sequential driving, a full-color image can be displayed by applying time integration to the red (R), green (G) and blue (B) fields displayed in this way.

In the above explanation, it is assumed that the color components included in a video signal are a red component, a green component and a blue component. However, the color components included in a video signal may be, for example, cyan, magenta and yellow. In this case, the green light source G and the blue light source B may be configured to emit light at the same time, and the red light source R and the blue light source B may be configured to emit light at the same time, and the red light source R and the green light source G may be configured to emit light at the same time.

For example, the color emitted by each light source may be arbitrarily changed (selected). Also, when a plurality of light sources emit light at the same time, the combination of colors emitted by the light sources may be arbitrarily changed (selected).

Here, in the liquid crystal display device 10, a video signal is written to the pixels PX arranged in matrix in the display area DA by scanning the pixels PX in series from the scanning starting row to the scanning completion row. The light from the light source 30 (the red light source R, the green light source G or the blue light source B) is emitted from the liquid crystal layer 21 which transitioned to a scattered state based on the video signal written to the pixels PX. In this way, an image is displayed.

In this case, the pixels PX are scanned in series from the scanning starting row to the scanning completion row. Thus, a delay occurs between the time point at which the liquid crystal starts a response in the pixels PX constituting the scanning starting row and the time point at which the liquid crystal starts a response in the pixels constituting the scanning completion row.

Wavy form 211 shown in FIG. 5 indicates the response of the liquid crystal in the scanning starting row (hereinafter, referred to as a first liquid crystal response). Wavy form 212 shown in FIG. 5 indicates the response of the liquid crystal in the scanning completion row (hereinafter, referred to as a second liquid crystal response).

Wavy forms 211 and 212 assume the response states of the liquid crystal in the case of red raster display for showing the entire display area DA in red. In the case of red raster display, control is performed so as to cause the liquid crystal to respond such that light from the red light source R is emitted from the liquid crystal layer 21 in an R period for displaying a red field and so as to cause the liquid crystal not to respond such that neither light from the green light source G nor light from the blue light source B is emitted from the liquid crystal layer 21 in a G period or a B period for displaying a green or blue field.

As shown in FIG. 5, the liquid crystal starts a response from the vicinity of the start point of the writing period of the red field in wavy form 211 (the first liquid crystal response), whereas the liquid crystal starts a response from the vicinity of the start point of the retention period of the red field in wavy form 212 (the second liquid crystal response). Thus, a delay occurs at the time point when the liquid crystal starts a response between the scanning starting row and the scanning completion row.

As indicated by wavy forms 211 and 212, the response speed of the liquid crystal is not sufficiently high. A certain time is required from the time point when the liquid crystal starts a response until the time point when the liquid crystal transitions to a state where it can sufficiently emit scattered light.

Wavy form 221 shown in FIG. 5 indicates the scattered light (hereinafter, referred to as first emission light) emitted from the liquid crystal layer 21 based on the light emission of the red light source R, the green light source G and the blue light source B and the first liquid crystal response. Wavy form 221 corresponds to the overlapping portion between the driving wavy forms of the red light source R, the green light source G and the blue light source B and wavy form 211 indicating the first liquid crystal response.

In the scanning starting row, the liquid crystal starts a response at a time point sufficiently earlier than the light emission start of the red light source R. Thus, as the first emission light, the light of the red light source R can be appropriately emitted from the start to the end of the light emission period (for example, the retention period) of the red light source R. In the light emission periods of the green light source G and the blue light source B, the liquid crystal does not respond. Thus, neither the light of the green light source G nor the light of the blue light source B is emitted as the first emission light.

Wavy form 222 shown in FIG. 5 indicates the scattered light (hereinafter, referred to as second emission light) emitted from the liquid crystal layer 21 based on the light emission of the red light source R, the green light source G and the blue light source B and the second liquid crystal response. Wavy form 222 corresponds to the overlapping portion between the driving wavy forms of the red light source R, the green light source G and the blue light source B and wavy form 212 indicating the second liquid crystal response.

In the scanning completion row, here, a delay occurs at the time point when the liquid crystal starts a response. Thus, even at the time of red raster display, the state in which the scattered light is emitted from the liquid crystal layer 21 is maintained until the light emission period of the green light source G. In this way, green light which should be originally blocked (in other words, which should not be emitted) is emitted as part of the second emission light.

However, the ratio of the amount of the green light emitted as part of the second emission light is less than that of the red light emitted as the second emission light. Thus, color mixture is not visually confirmed.

Here, when the brightness of the image displayed in the liquid crystal display device 10 of the present embodiment is adjusted (in other words, light control), the light emission period (time) of the light source 30 is controlled by modulating the pulse width of the voltage applied to the light source 30 (the red light source R, the green light source G and the blue light source B). The modulation of the pulse width of the voltage applied to the light source 30 is referred to as pulse width modulation (PWM).

By the PWM control, the brightness of an image can be increased when the light emission period of the light source 30 is long, and the brightness of an image can be decreased when the light emission period of the light source 30 is short.

In the present embodiment, PWM control is performed for light control. However, PWM control may be performed for the gradation display of an image.

The above FIG. 5 shows an example in which an image is displayed with a maximum brightness. When an image is displayed with a maximum brightness in the present embodiment, the light emission period of each of the red, green and blue light sources R, G and B corresponds to the period from the starting time to the completion time of a retention period.

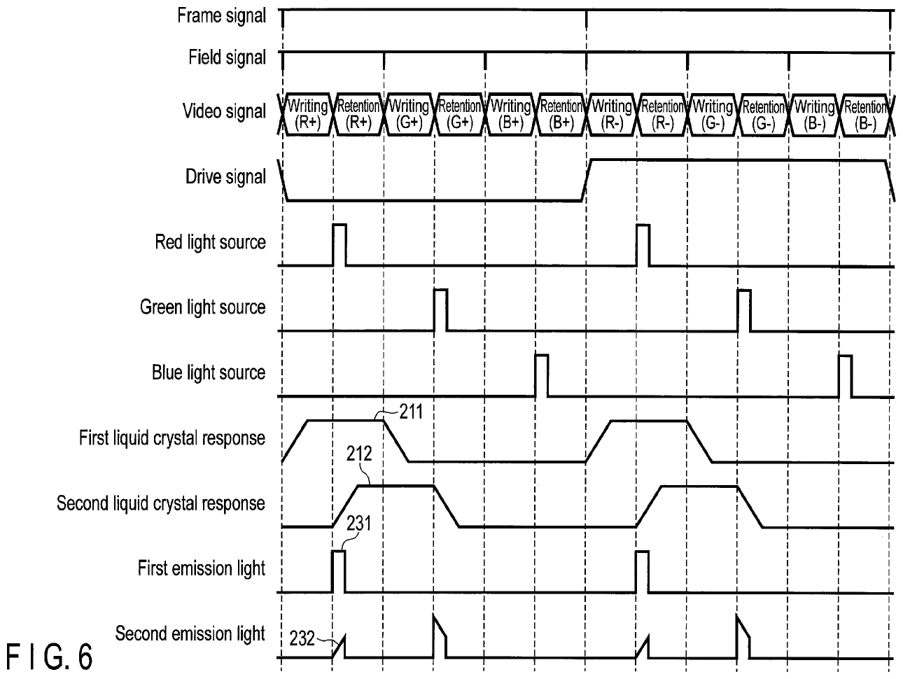

Now, this specification explains a case where an image is displayed with a minimum brightness. This specification explains the outline of the operation of a liquid crystal display device according to a comparison example of the present embodiment when an image is displayed with a minimum brightness with reference to FIG. 6. In the explanation of FIG. 6, the same reference numbers are added to the same portions as FIG. 5, detailed description thereof being omitted. Here, portions different from FIG. 5 are mainly explained.

As shown in FIG. 6, when an image is displayed with a minimum brightness, the light emission periods of the red light source R, the green light source G and the blue light source B are shorter than those when an image is displayed with a maximum brightness as shown in FIG. 5. In the comparison example of the present embodiment, the red, green and blue light sources R, G and B emit light in the period from the light emission starting time of a case where an image is displayed with a maximum brightness until a light emission stopping time earlier than the light emission stopping time of a case where the image is displayed with a maximum brightness. In other words, in the comparison example of the present embodiment, the light emission periods of the red, green and blue light sources R, G and B are controlled based on the light emission starting time of a case where an image is displayed with a maximum brightness.

In this case, the amount of the first emission light indicated by wavy form 231 is comparatively less than the amount of the first emission light of a case where an image is displayed with a maximum brightness (in other words, the first emission light indicated by wavy form 221 of FIG. 5). Thus, the brightness of an image can be made low. Wavy form 231 corresponds to the overlapping portion between the driving wavy forms of the red light source R, the green light source G and the blue light source B and wavy form 211 indicating the first liquid crystal response in FIG. 6.

The amount of the second emission light indicated by wavy form 232 is less than the amount of the first emission light indicated by wavy form 231 because of the delay at the time point when the liquid crystal starts a response in the second liquid crystal response. Thus, the brightness of an image is further decreased. Wavy form 232 corresponds to the overlapping portion between the driving wavy forms of the red light source R, the green light source G and the blue light source B and wavy form 212 indicating the second liquid crystal response in FIG. 6.

Here, green light is also emitted as the second emission light indicated by wavy form 232. However, in a manner different from the above case where an image is displayed with a maximum brightness, the ratio of the amount of the green light emitted in the scanning completion row when an image is displayed with a minimum brightness in the comparison example of the present embodiment is greater than that of the red light emitted in the scanning completion row. When the display panel 20 in this state is observed, color mixture is visually confirmed.

As described above, in the liquid crystal display device of the comparison example of the present embodiment, for example, when an image is displayed with a minimum brightness (in other words, at the time of the least light control), color mixture is generated, and the display quality of the liquid crystal display device may be degraded. In the above explanation, an image is displayed with a minimum brightness. However, color mixture may be generated when an image is displayed with a low brightness, even not with a minimum brightness.

To avoid this color mixture, for example, the light emission periods of the red, green and blue light sources R, G and B may be shortened when an image is displayed with a maximum brightness such that the period in which the liquid crystal layer 21 is in a state allowed to emit scattered light in the second liquid crystal response having a delay at the time point when the liquid crystal starts a response does not overlap the light emission period of the light source (here, the green light source G) other than the light sources of corresponding colors. However, when the light emission periods of the red, green and blue light sources R, G and B are shortened, the brightness is decreased.

Thus, the liquid crystal display device 10 of the present embodiment operates so as to prevent the above degradation of the display quality of the liquid crystal display device 10 (in other words, to prevent the generation of color mixture) without shortening the light emission periods of the red, green and blue light sources R, G and B.

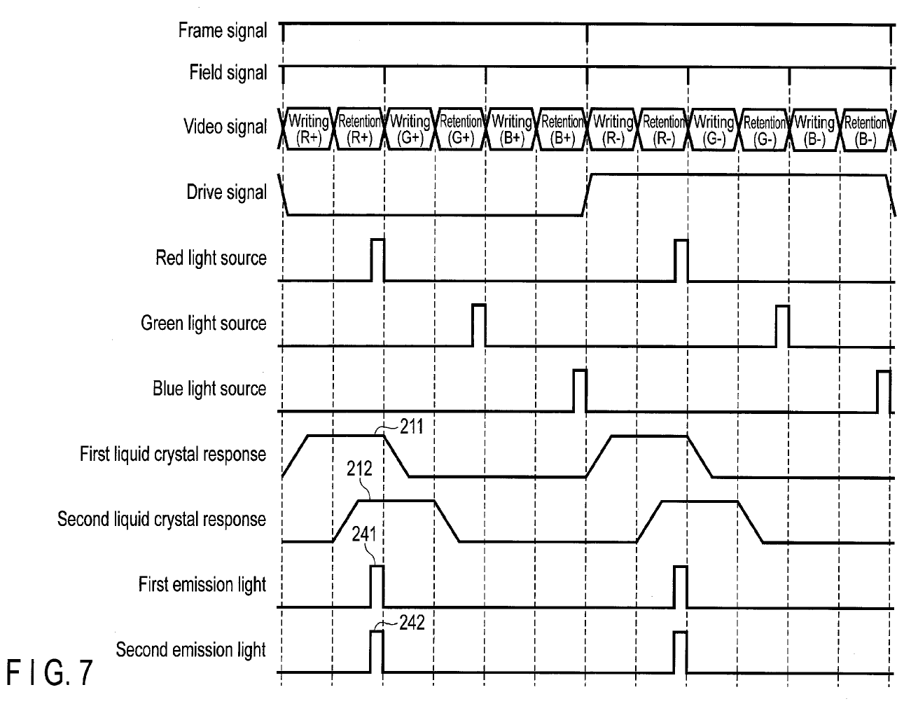

FIG. 7 shows the outline of the operation of the liquid crystal display device 10 according to the present embodiment when an image is displayed with a minimum brightness. In the explanation of FIG. 7, the same reference numbers are added to the same portions as FIG. 5 and FIG. 6, detailed description thereof being omitted. Here, portions different from FIG. 6 are mainly explained.

When an image is displayed with a minimum brightness as described above, the light emission periods of the red, green and blue light sources R, G and B are shortened in comparison with a case where an image is displayed with a maximum brightness. At this time, in the liquid crystal display device 10 of the present embodiment, the red, green and blue light sources R, G and B are caused to emit light in the period from a light emission starting time (a second light emission starting time) later than the light emission starting time (a first light emission starting time) of a case where an image is displayed with a maximum brightness until the light emission stopping time of a case where an image is displayed with a maximum brightness. In other words, in the PWM control of the present embodiment, the light emission stopping time is fixed (as a basis) and the brightness of an image (in other words, the amount of light emission of the light source of each color) is adjusted by shifting the time points when the light emission of the red, green and blue light sources R, G and B starts.

In this case, the time point of the first emission light indicated by wavy form 241 (in other words, the time point when scattered light is emitted from the liquid crystal) is different from that of the first emission light indicated by wavy form 231 shown in FIG. 6. However, the amount of the first emission light is the same. Wavy form 241 corresponds to the overlapping portion between the driving wavy forms of the red light source R, the green light source G and the blue light source B and wavy form 211 indicating the first liquid crystal response in FIG. 7.

Here, the amount of the second emission light indicated by wavy form 232 shown in the above FIG. 6 is less than the amount of the first emission light because of the delay at the time point when the liquid crystal starts a response in the second liquid crystal response. However, the amount of the second emission light indicated by wavy form 242 is the same as the amount of the first emission light indicated by the above wavy form 241.

Thus, in the present embodiment, even in the case of the second liquid crystal response (in other words, even when a delay occurs at the time point when the liquid crystal starts a response), the same brightness as the first liquid crystal response (in other words, when a delay does not occur at the time point when the liquid crystal starts a response) can be maintained.

In addition, in the present embodiment, the light emission stopping time is fixed, and the time point for staring light emission is delayed. Thus, even in the case of the second liquid crystal response, green light is not emitted as the second emission light, and color mixture is not generated.

The control for causing the red light source R, the green light source G and the blue light source B to emit light as described above is performed by the light source drive circuit 44 (and the timing controller 45) shown in FIG. 4.

As described above, in the present embodiment, at least one of the light sources R, G and B (for example, the red light source R) is caused to emit light in the period from the first light emission starting time until the light emission stopping time when an image is displayed with a first brightness (for example, a maximum brightness). At least one of the light sources R, G and B (for example, the red light source R) is caused to emit light in the period from the second light emission starting time later than the first light emission starting time until the above light emission stopping time when an image is displayed with a second brightness (for example, a minimum brightness) less than the first brightness.

In the present embodiment, the light emission starting position (the light emission rising position) when an image is displayed with the second brightness is set in the latter half of the light emission period of each of the light sources R, G and B, thereby improving color mixture at the time of displaying an image with a minimum brightness. In this way, the degradation of the display quality can be prevented. Further, in the present embodiment, there is no need to shorten the light emission period of each of the light sources R, G and B (the light emission period when an image is displayed with a maximum brightness). Thus, the brightness is not degraded.

In the present embodiment, as indicated by wavy form 232 shown in FIG. 6 and wavy form 242 shown in FIG. 7, it is possible to prevent a light emission loss (in other words, the decrease in the amount of the second emission light) caused by the delay at the time point when the liquid crystal starts a response in the scanning completion row.

In the present embodiment, the period from the light emission starting time until the light emission stopping time when an image is displayed with a maximum brightness is assumed to be a period corresponding to the retention period in which the video signal written to pixels PX is retained in the pixels. In this way, the light from each of the light sources R, G and B can be appropriately emitted from the liquid crystal layer 21 based on the video signal written to the pixels PX.

In the present embodiment, for convenience sake, this specification explains a case where an image is displayed with a maximum brightness and a case where an image is displayed with a minimum brightness. However, the same explanation is applied to a case where an image is displayed with a brightness other than a maximum brightness and a minimum brightness. The present embodiment should be configured only such that the brightness is adjusted by fixing the light emission stopping period and shifting the time point for staring the light emission of each of the light sources R, G and B. For example, when an image is displayed with a low brightness, PWM control should be performed such that the light emission starting time of each of the light sources R, G and B is delayed in comparison with a case where an image is displayed with a high brightness.

In the present embodiment, this specification mainly explains the liquid crystal display device (transparent display) 10 using a polymer dispersed liquid crystal. However, the present embodiment may be applied to other liquid crystal display devices as long as the liquid crystal display device adopts field sequential driving.

### Second Embodiment

Now, this specification explains a second embodiment. Regarding the structures, etc., of the liquid crystal display device of the present embodiment, the detailed description of the same portions as the first embodiment is omitted. In the following explanation, FIG. 1 to FIG. 4, etc., are referred to as needed.

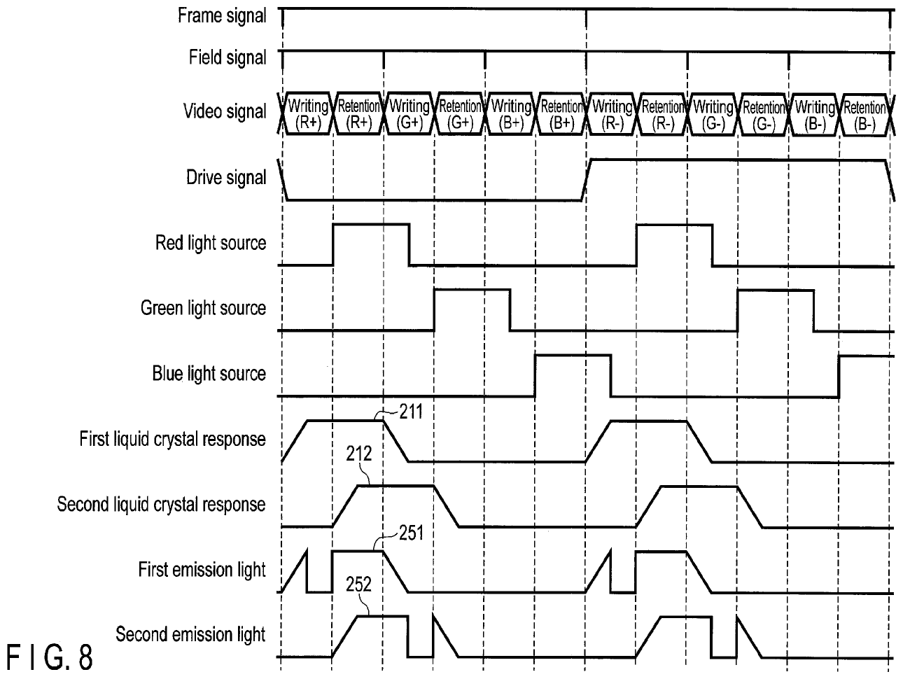

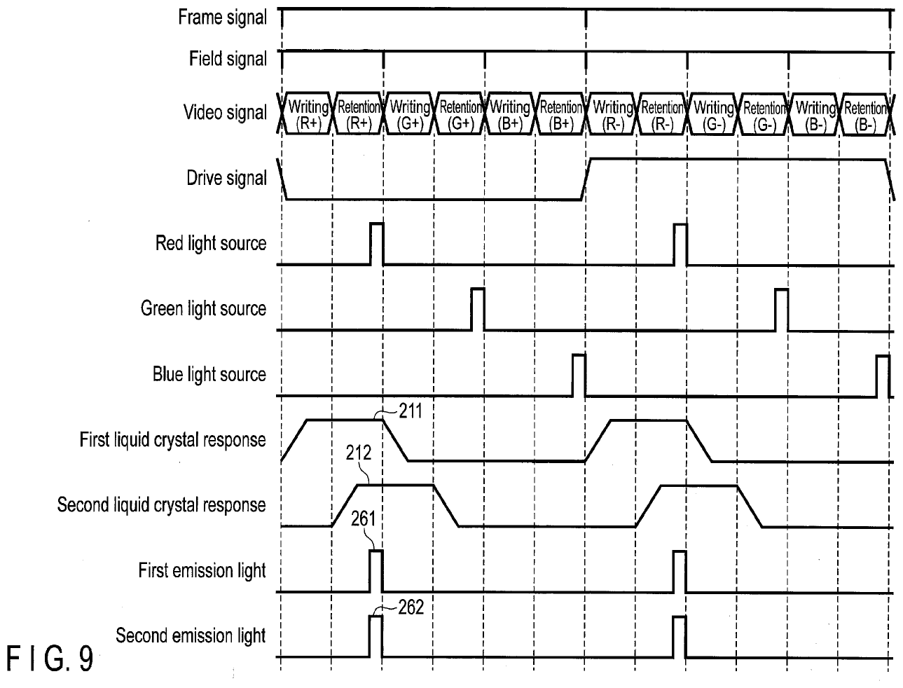

FIG. 8 shows the outline of the operation of a liquid crystal display device 10 according to the present embodiment when an image is displayed with a maximum brightness. FIG. 8 assumes the case of red raster display in a manner similar to that of FIG. 5 to FIG. 7.

In the explanation of FIG. 8, the same reference numbers are added to the same portions as FIG. 5 to FIG. 7 described above, detailed description thereof being omitted. Here, portions different from FIG. 5 are mainly explained.

In the first embodiment, the red, green and blue light sources R, G and B are caused to emit light in a period corresponding to a retention period. In the present embodiment, as shown in FIG. 8, in addition to a period corresponding to a retention period, the red, green and blue light sources R, G and B are caused to emit light in a part of the writing period provided after the retention period. Specifically, when an image is displayed with a maximum brightness, for example, the red, green and blue light sources R, G and B are caused to emit light in the period from the starting time of a retention period until a middle point of the writing period provided after the retention period.

Here, wavy form 251 indicates the scattered light (first emission light) emitted from a liquid crystal layer 21 based on the light emission of the red light source R, the green light source G and the blue light source B and a first liquid crystal response in FIG. 8. Wavy form 251 corresponds to the overlapping portion between the driving wavy forms of the red light source R, the green light source G and the blue light source B and wavy form 211 indicating the first liquid crystal response.

According to wavy form 251 shown in FIG. 8, in addition to the retention period of the red field (R period), red light (in other words, light from the red light source R) is emitted as the first emission light in a part of the writing period of the next green field (G period).

Wavy form 252 indicates the scattered light (second emission light) emitted from the liquid crystal layer 21 based on the light emission of the red light source R, the green light source G and the blue light source B and a second liquid crystal response in FIG. 8. Wavy form 252 corresponds to the overlapping portion between the driving wavy forms of the red light source R, the green light source G and the blue light source B and wavy form 212 indicating the second liquid crystal response.

According to wavy form 252 shown in FIG. 8, in addition to the retention period of the red field (R period), red light (in other words, light from the red light source R) is emitted as the second emission light in a part of the writing period of the next green field (G period).

Thus, in the present embodiment, when an image is displayed with a maximum brightness, the amount of the first emission light and the second emission light can be made greater than the amount of the first emission light and the second emission light in the first embodiment. Thus, an image can be displayed with a higher brightness.

Here, according to wavy forms 221 and 222 shown in the above FIG. 5, when an image is displayed with a maximum brightness, the amount of the light (the second emission light) emitted from the liquid crystal layer 21 in the scanning completion row is less than the amount of the light (the first emission light) emitted from the liquid crystal in the scanning starting row.

However, the amount of the second emission light indicated by wavy form 252 shown in FIG. 8 is substantially equal to the amount of the first emission light indicated by wavy form 251.

Thus, in the present embodiment, it is possible to prevent the degradation in the display quality caused by the difference in the brightness of the image between the scanning starting row and the scanning completion row.

As shown in wavy form 251 of FIG. 8, blue light is emitted as part of the first emission light at the time of red raster display described above by extending the light emission period of each of the red, green and blue light sources R, G and B. However, the ratio of the amount of the blue light emitted as part of the first emission light is less than that of the red light emitted as the first emission light. Thus, color mixture is not visually confirmed.

Similarly, as shown in wavy form 252 of FIG. 8, green light is emitted as part of the second emission light at the time of red raster display described above by extending the light emission period of each of the red, green and blue light sources R, G and B. However, the ratio of the amount of the green light emitted as part of the second emission light is less than that of the red light emitted as the second emission light. Thus, color mixture is not visually confirmed.

FIG. 9 shows the outline of the operation of the liquid crystal display device 10 according to the present embodiment when an image is displayed with a minimum brightness. In the explanation of FIG. 9, the same reference numbers are added to the same portions as FIG. 5 to FIG. 8, detailed description thereof being omitted. Here, portions different from FIG. 8 are mainly explained.

When an image is displayed with a minimum brightness as described above, the light emission periods of the red, green and blue light sources R, G and B are shortened in comparison with a case where an image is displayed with a maximum brightness.

In the first embodiment, an image is displayed with a minimum brightness by PWM control for fixing the light emission stopping period and delaying the time point at which the light emission of the red, green and blue light sources R, G and B. In the present embodiment, when this PWM control is performed, for example, the amount of the scattered light (the first emission light) emitted from the liquid crystal layer 21 in the scanning starting row may be insufficient.

When an image is displayed with a minimum brightness in the present embodiment, the red, green and blue light sources R, G and B are caused to emit light in the period from a light emission starting time (a second light emission starting time) later than the light emission starting time (a first light emission starting time) of a case where an image is displayed with a maximum brightness until a light emission stopping time (a second light emission stopping time) earlier than the light emission stopping time (a first light emission stopping time) of a case where an image is displayed with a maximum brightness. In other words, in the PWM control of the present embodiment, the brightness of an image (in other words, the amount of the light emission of the light source of each color) is controlled by adjusting the light emission period such that the light emission starting time is close to the light emission stopping time.

As shown in FIG. 9, the light emission stopping time when an image is displayed with a minimum brightness corresponds to the completion time of a retention period in a manner similar to that of the first embodiment described above.

According to this configuration, as shown in wavy forms 261 and 262 of FIG. 9, the light from the red light source R can be appropriately emitted as the first emission light and the second emission light even in the scanning starting row (the first liquid crystal response) or the scanning completion row (the second liquid crystal response).

As described above, in the present embodiment, when an image is displayed with a first brightness (for example, a maximum brightness), at least one (for example, the red light source R) of the light sources R, G and B is caused to emit light in the period from the first light emission starting time until the first light emission stopping time. When an image is displayed with a second brightness (for example, a minimum brightness), at least one of the light sources R, G and B is caused to emit light in the period from the second light emission starting time later than the first light emission starting time until the second light emission stopping time earlier than the first light emission stopping time.

Specifically, the period from the first light emission starting time until the first light emission stopping time when the first brightness is the maximum brightness is a period corresponding to the retention period in which the video signal written to pixels PX is retained in the pixels PX and at least a part of the writing period for writing the next video signal to the pixels.

In the present embodiment, this configuration allows the display of an image with a higher brightness than the first embodiment described above when an image is displayed with a maximum brightness.

In the present embodiment, the second light emission stopping time when the second brightness is the minimum brightness corresponds to the completion time of the retention period. This configuration prevents color mixture and the degradation of the display quality when an image is displayed with the minimum brightness in a manner similar to that of the first embodiment.

According to the structure of the present embodiment described above, it is possible to realize both high brightness and the improvement of color mixture at the time of image display with a low brightness in the entire display area DA (display screen) as well as the vicinity of the scanning starting row and the vicinity of the scanning completion row.

In the present embodiment, the second light emission stopping time when an image is displayed with a minimum brightness corresponds to the completion time of a retention period. However, the second light emission starting time and the second light emission stopping time when an image is displayed with a minimum brightness are not limited to the example explained in the present embodiment as long as the brightness of the image can be assured, and color mixture can be prevented.

Specifically, when the second light emission starting time is the starting time of a retention period, color mixture occurs, and when the second light emission stopping time is the same as the first light emission stopping time of a case where an image is displayed with a maximum brightness, the brightness is decreased. Thus, for example, the second light emission starting time and the second light emission stopping time (in other words, the light emission period of each of the red, green and blue light sources R, G and B) when an image is displayed with a minimum brightness should be set so as to be positioned around the central portion of the light emission period of each of the red, green and blue light sources R, G and B (in other words, the period from the first light emission starting time until the first light emission stopping time) when an image is displayed with a maximum brightness.

According to at least one of the embodiments explained above, it is possible to provide a liquid crystal display device which allows the prevention of the degradation of the display quality.

Hereinafter, the invention of the present embodiment is additionally described.

### [C1]

A liquid crystal display device including:

a plurality of light sources having different light emission colors;

a display panel including a liquid crystal layer irradiated by the light sources; and

a driver configured to cause the light sources to emit light in series in a time-divisional matter to display an image on the display panel, wherein

the driver is configured to cause at least one of the light sources to emit light in a period from a first light emission starting time until a light emission stopping time when the image is displayed with a first brightness, and configured to cause at least one of the light sources to emit light in a period from a second light emission starting time later than the first light emission starting time until the light emission stopping time when the image is displayed with a second brightness less than the first brightness.

### [C2]

The liquid crystal display device of [C1], wherein

the display panel includes pixels arranged in matrix, and

the period from the first light emission starting time until the light emission stopping time when the first brightness is a maximum brightness is a period corresponding to a retention period in which a video signal written to the pixels is retained in the pixels.

### [C3]

A liquid crystal display device including:

a plurality of light sources having different light emission colors;

a display panel including a liquid crystal layer irradiated by the light sources; and

a driver configured to cause the light sources to emit light in series in a time-divisional manner to display an image on the display panel, wherein

the driver is configured to cause at least one of the light sources to emit light in a period from a first light emission starting time until a first light emission stopping time when the image is displayed with a first brightness, and configured to cause at least one of the light sources to emit light in a period from a second light emission starting time later than the first light emission starting time until a second light emission stopping time earlier than the first light emission stopping time when the image is displayed with a second brightness less than the first brightness.

### [C4]

The liquid crystal display device of [C3], wherein

the display panel includes pixels arranged in matrix, and

the period from the first light emission starting time until the first light emission stopping time when the first brightness is a maximum brightness is a period corresponding to a retention period in which a video signal written to the pixels is retained in the pixels and at least a part of a writing period for writing a next video signal to the pixels.

### [C5]

The liquid crystal display device of [C4], wherein

the second light emission stopping time when the second brightness is a minimum brightness corresponds to a completion time of the retention period.

### [C6]

The liquid crystal display device of one of [C1] to [C5], wherein

the liquid crystal layer includes a polymer dispersed liquid crystal layer.

### [C7]

A method performed by a liquid crystal display device including:

a plurality of light sources having different light emission colors;

a display panel including a liquid crystal layer irradiated by the light sources; and

a driver is configured to cause the light sources to emit light in series in a time-divisional manner to display an image on the display panel,

the method including:

causing at least one of the light sources to emit light in a period from a first light emission starting time until a light emission stopping time when the image is displayed with a first brightness, and

causing at least one of the light sources to emit light in a period from a second light emission starting time later than the first light emission starting time until the light emission stopping time when the image is displayed with a second brightness less than the first brightness.

### [C8]

The method of [C7], wherein

the display panel includes pixels arranged in matrix, and

the period from the first light emission starting time until the light emission stopping time when the first brightness is a maximum brightness is a period corresponding to a retention period in which a video signal written to the pixels is retained in the pixels.

### [C9]

A method performed by a liquid crystal display device including:

a plurality of light sources having different light emission colors;

a display panel including a liquid crystal layer irradiated by the light sources; and

a driver is configured to cause the light sources to emit light in series in a time-divisional manner to display an image on the display panel,

the method including:

causing at least one of the light sources to emit light in a period from a first light emission starting time until a first light emission stopping time when the image is displayed with a first brightness, and causing at least one of the light sources to emit light in a period from a second light emission starting time later than the first light emission starting time until a second light emission stopping time earlier than the first light emission stopping time when the image is displayed with a second brightness less than the first brightness.

### [C10]

The method of [C9], wherein

the display panel includes pixels arranged in matrix, and

the period from the first light emission starting time until the first light emission stopping time when the first brightness is a maximum brightness is a period corresponding to a retention period in which a video signal written to the pixels is retained in the pixels and at least a part of a writing period for writing a next video signal to the pixels.

### [C11]

The method of [C10], wherein

the second light emission stopping time when the second brightness is a minimum brightness corresponds to a completion time of the retention period.

### [C12]

The method of one of [C7] to [C11], wherein

the liquid crystal layer includes a polymer dispersed liquid crystal layer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display device comprising:
a plurality of light sources having different light emission colors;
a display panel comprising a liquid crystal layer irradiated by the light sources; and
a driver configured to cause the light sources to emit light in series in a time-divisional matter to display an image on the display panel, wherein
the driver is configured to cause at least one of the light sources to emit light in a period from a first light emission starting time until a light emission stopping time when the image is displayed with a first brightness, and configured to cause at least one of the light sources to emit light in a period from a second light emission starting time later than the first light emission starting time until the light emission stopping time when the image is displayed with a second brightness less than the first brightness.

2. The liquid crystal display device of claim 1, wherein
the display panel comprises pixels arranged in matrix, and
the period from the first light emission starting time until the light emission stopping time when the first brightness is a maximum brightness is a period corresponding to a retention period in which a video signal written to the pixels is retained in the pixels.

3. A liquid crystal display device comprising:
a plurality of light sources having different light emission colors;
a display panel comprising a liquid crystal layer irradiated by the light sources; and
a driver configured to cause the light sources to emit light in series in a time-divisional manner to display an image on the display panel, wherein
the driver is configured to cause at least one of the light sources to emit light in a period from a first light emission starting time until a first light emission stopping time when the image is displayed with a first brightness, and configured to cause at least one of the light sources to emit light in a period from a second light emission starting time later than the first light emission starting time until a second light emission stopping time earlier than the first light emission stopping time when the image is displayed with a second brightness less than the first brightness.

4. The liquid crystal display device of claim 3, wherein
the display panel comprises pixels arranged in matrix, and
the period from the first light emission starting time until the first light emission stopping time when the first brightness is a maximum brightness is a period corresponding to a retention period in which a video signal written to the pixels is retained in the pixels and at least a part of a writing period for writing a next video signal to the pixels.

5. The liquid crystal display device of claim 4, wherein
the second light emission stopping time when the second brightness is a minimum brightness corresponds to a completion time of the retention period.

6. The liquid crystal display device of claim 1, wherein
the liquid crystal layer comprises a polymer dispersed liquid crystal layer.

7. A method performed by a liquid crystal display device comprising:
a plurality of light sources having different light emission colors;
a display panel comprising a liquid crystal layer irradiated by the light sources; and
a driver configured to cause the light sources to emit light in series in a time-divisional manner to display an image on the display panel,
the method comprising:
causing at least one of the light sources to emit light in a period from a first light emission starting time until a light emission stopping time when the image is displayed with a first brightness, and
causing at least one of the light sources to emit light in a period from a second light emission starting time later than the first light emission starting time until the light emission stopping time when the image is displayed with a second brightness less than the first brightness.

8. The method of claim 7, wherein
the display panel comprises pixels arranged in matrix, and
the period from the first light emission starting time until the light emission stopping time when the first brightness is a maximum brightness is a period corresponding to a retention period in which a video signal written to the pixels is retained in the pixels.
